(19) United States
(12) Patent Application Publication
(10) Pub. No.: US 2010/0254385 A1
(43) Pub. Date: Oct. 7, 2010

(54) Service Insertion Architecture (SIA) in a Virtual Private Network (VPN) Aware Network

(75) Inventors: Govind Prasad Sharma, Union City, CA (US); Mohamed Khalid, Cary, NC (US); Shree Murthy, San Jose, CA (US); Rajiv Asati, Morrisville, NC (US)

Correspondence Address: PATTERSON & SHERIDAN, LLP/CISC, 3040 POST OAK BLVD., SUITE 1500, HOUSTON, TX, 77056-6582, US

(73) Assignee: CISCO TECHNOLOGY, INC., San Jose, CA (US)

(21) Appl. No.: 12/419,569

(22) Filed: Apr. 7, 2009

(51) Int. Cl. H04L 12/56; H04L 12/54

(52) U.S. Cl. 370/392; 370/428

(57) ABSTRACT

Systems, methods, and other embodiments associated with interworking a VPN and an SIA are described. One example apparatus includes a mapping data store to store a mapping between two logical groups of network devices having separate forwarding planes that are at least partially incompatible. The apparatus includes an instantiation logic to establish the mapping based on unique identifiers associated with the logical groups. The apparatus also includes an encoding logic to implicitly encode information to identify the first logical group in a packet received from the first logical group, provided to the second logical group, and then provided back to the first logical group. The implicitly encoded information is configured to be used without modification by the forwarding plane associated with the second logical group and is configured to facilitate a member of the second logical group resolving the mapping.

### BACKGROUND

Service Insertion Architecture (SIA) provides a platform independent framework for inserting services into a network. A service may be regarded as a feature that performs packet manipulations over and beyond the conventional packet forwarding. For example, a service may be an application that operates at one or more of, layers three (L3) (Network) through seven (L7) (Application). A service may be considered to be an optional function performed in a network that provides connectivity to a network user. Services include, but are not limited to, encryption, decryption, firewall, server load balancing, intrusion management, accounting, and so on. A service may be distributed throughout members of a service path. The members may be referred to as service nodes.

SIA includes a control plane entity that is known as a service broker (SB). Service Nodes register with a service broker and thus a service broker can provide a consistent domain-wide service view. A service may be implemented as a service path. A service path may be organized as an ordered list of path segments, where a segment represents a service feature provided by a service node. A service broker can, therefore, instantiate service paths when service nodes are registered.

A consumer of a service may be referred to as a service classifier (SCL). A service broker can allocate a service path to a consumer when the consumer registers with the broker. A service broker may also distribute information concerning service path segments to service nodes and to consumers to facilitate setting up the data plane for the SIA.

Both an SIA and a VPN have respective data planes and control planes. An SIA may interact with a VPN. When an SIA interacts with a VPN, there may be interactions in both the data planes and control planes at the interfaces between the SIA and the VPN. These interactions may affect a logical forwarding plane for the SIA-VPN combination. For example, when a VPN packet interacts with an SIA, the packet may travel from the packet's VPN forwarding plane to the SIA forwarding plane and then back to the packet's VPN forwarding plane to reach its original destination. When a VPN interacts with SIA, the two forwarding planes may be in two different forwarding domains. For example, the SIA forwarding plane may be in a global forwarding domain while the packet forwarding plane may be in a private forwarding domain.

To illustrate, consider a day in the life of a packet associated with a VPN that interacts with an SIA. The packet will enter the VPN plane, traverse some of the VPN plane, and then exit the VPN plane as it enters the SIA plane. The packet will then traverse an SIA service path using the SIA forwarding plane and ultimately reach the end of the SIA service path. At this point the packet will exit the SIA plane and desire to re-enter the VPN plane. Conventionally it has been difficult, if even possible, to re-enter the VPN plane due to the loss of VPN information that was available when the packet left the VPN plane and entered the SIA plane. The VPN information may not have been available when the packet was ready to leave the SIA plane. Complex signaling protocols may have mitigated some of these issues, but with undesirable and/or unacceptable levels of complexity, processing requirements, and/or timing delays.

In the SIA data plane, a service classifier intercepts certain packets and redirects them onto the service path. The traffic in the service path flows from one service node to another service node and from one service to another service until a final service node is reached. This final service node is responsible for forwarding the packet to its original destination. If the original destination was part of the global forwarding plane, this may be a straightforward task. However, if the original destination was part of a private forwarding plane, conventionally this may have been difficult, if even possible at all.

SIA is described in United States Patent Application US 2008/0177896. One attribute of an SIA is network topology independence. Services may reside at different locations in a network, independent of network path or network node deployment. Another attribute of SIA is inter-service communication. This communication facilitates a state sharing mechanism to path services together and to share information between those services. Another attribute is service topology independence. This attribute concerns how the actual form (e.g., distributed, centralized, clustering) of a service does not matter. SIA also provides consistent administration and management policies. These attributes facilitate SIA redirection, where packets may be redirected to an appropriate service node in a network independent of the physical location of that service node. The packets can be forwarded based on their service header within the SIA service path.

Understanding the SIA data plane functions includes examining classification and SIA context tagging, SIA header insertion, redirection, service selection, and packet forwarding. A service classifier intercepts traffic desiring a service and adds a unique identifier to packets that enter the relevant service path. The unique identifier may be, for example, a service header identifier. The service header identifier may convey the classification context that resulted from the traffic classification. Service nodes in the service path apply service specific policies to packets as a function of information conveyed in the service header. The service header identifier may remain unchanged as a packet traverses a service path.

Redirection occurs at the data plane level as SIA physical devices forward tagged packets to the next physical device in a service path. The SIA physical devices may include service classifiers and service nodes. Ultimately, at the end of the service path, a service node will be responsible for handing a packet to a routing plane. Adding additional information to an SIA packet to facilitate handing the packet to the next routing plane may have included complex signaling protocols and/or updating each member of a service path. This has generally been unacceptable. The redirection performed by service nodes in the service path may rely on transport mechanisms available in an underlying network. Logically and/or physically adjacent peer SIA devices share redirection encapsulation. This redirection encapsulation facilitates carrying SIA traffic for multiple service paths that flow between the logically and/or physically adjacent SIA devices.

Service selection involves forwarding an SIA packet to an appropriate logical service. This action occurs in the SIA forwarding plane. The SIA forwarding plane may be physically and/or logically separate from the service plane where the actual service is performed. The SIA forwarding plane may rely on an SIA header that includes a classification context identifier and a service sequence number. The SIA header may determine the next hop transport encapsulation.

Recall the day in the life of a packet. An SIA packet travels from the packet's forwarding plane to the SIA forwarding plane and back to the packet forwarding plane to reach the original destination known to the packet's forwarding plane. However, when an SIA interacts with a VPN, these two planes are in two different, potentially incompatible, potentially un-resolvable, forwarding domains. The SIA forwarding plane is in a global forwarding plane while the packet forwarding plane may be in a private plane associated with the VPN. Conventional attempts to resolve this issue may have involved complex signaling protocols and/or updating every member of a service path, both of which are sub-optimal.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example apparatus associated with interworking a VPN and an SIA.

FIG. 2 illustrates another example apparatus associated with interworking a VPN and an SIA.

FIG. 3 illustrates another example apparatus associated with interworking a VPN and an SIA.

FIG. 4 illustrates an example environment in which a VPN and an SIA interact.

FIG. 5 illustrates an example environment in which a VPN and an SIA interact.

FIG. 6 illustrates an example method associated with interworking a VPN and an SIA.

FIG. 7 illustrates another example method associated with interworking a VPN and an SIA.

FIG. 8 illustrates an example computing environment in which example systems and methods, and equivalents, may operate.

### BRIEF OVERVIEW

Example systems and methods implicitly encode VPN information in the SIA data plane. VPN information, which is derived at the entry to the SIA plane, is preserved in the packet in the SIA plane and used at the exit from the SIA plane to facilitate forwarding a packet to the original VPN destination. The VPN information may be implicitly encoded by a service classifier device that intercepts the packet and provides it to the service path. The VPN information may be decoded by a service node or a service classifier at the end of a service path and thus at an exit point from the SIA plane. “Implicitly encoding” the VPN information means using a field that would already appear in an SIA packet (e.g., service header) for dual purposes that satisfy both an SIA function and a VPN function.

In one embodiment, a VPN identifier uniquely identifies a VPN in the SIA domain network. The VPN identifier may be, for example, a Global VPN Identifier as described in RFC 2685, a VNET identifier associated with Cisco's Network Virtualization technology, a Route-target as described in RFC 4364, and so on. One skilled in the art will appreciate that different unique VPN identifiers may take different forms and that different unique VPN identifiers may be employed.

In one embodiment, a service broker establishes, maintains, and distributes mappings. A mapping may be between a VPN identifier and a service header. In one example, the traffic classification identifier in the service header may be used to implicitly encode the VPN information. Thus, information concerning the mapping may be stored in the service header. The information can function both as SIA data and as VPN to SIA mapping resolving data. Note that the VPN information need not be the VPN identifier, but rather may be data that facilitates deriving a VPN identifier.

In one embodiment, a service classifier will pass the VPN identifier to a service broker when the service classifier requests a service path as part of registration. The VPN identifier may be part of the VPN configuration and/or classification context. The service broker may allocate a globally distinct service header for a classification context per VPN using the received VPN identifier. The service broker maintains the mapping between the VPN identifier and the service header. The service broker also selectively provides mapping data to service nodes and/or service classifiers. In one example, the service broker may provide VPN identifier to service header mapping data when the service broker distributes path segment information. In one embodiment, the service broker may only distribute VPN identifier to service header mapping data to service path entry points and service path exit points.

A service path entry point may therefore implicitly encode VPN routing information in an SIA packet using the VPN identifier to service header mapping. A service path exit point may decode VPN routing information from the service header using the VPN identifier to service header mapping. While a service path entry point and a service path exit point are described, in the SIA data plane, service nodes and service classifiers may maintain the VPN identifier to service header mapping in, for example, an SIA switching table. When the last service node in a service path receives an SIA data packet, it can be controlled to resolve the VPN identifier to service header mapping to derive corresponding VPN routing information. The VPN routing information may include, for example, VPN forwarding table information.

Since VPN identification information is implicitly encoded in a service header, it may not be necessary to explicitly transmit a VPN identifier, which facilitates simplifying VPN forwarding in an SIA domain. By way of illustration, VPN forwarding may be simplified because the SIA forwarding plane is transparent to VPNs. Therefore, routing may not depend on a VPN label exchange mechanism between physical devices in the SIA domain. By way of further illustration, routing may also not depend on additional information being tagged in an SIA packet for transporting VPN information in the SIA data plane. Therefore the SIA forwarding plane and the service plane implementations become consistent with both VPN and non-VPN cases. By way of further illustration, virtualization is provided in the SIA domain without services actually being aware of VPNs. The service header identifiers are available for virtualization by the services in an SIA domain. Since the services are transparent to VPNs, the services can be shared among multiple VPNs in an SIA domain, greatly improving the efficacy of the service utilization.

One skilled in the art will appreciate that the mapping, encoding, and decoding may be implemented in different combinations of hardware and/or software. For example, in a primarily software based platform the mapping may be maintained in an SIA switching table that stores path segment information for SIA packet switching. In a primarily hardware based platform, mapping, encoding, and/or decoding functions required for this scheme may leverage the existing multi-protocol label switching (MPLS) VPN forwarding information base (FIB) ternary content addressable memory (TCAM) of a forwarding application specific integrated circuit (ASIC). For example, a service header identifier may function as the MPLS label in an MPLS VPN FIB table and can derive the VPN table identifier. A VPN forwarding table can then be selected as a function of the VPN table identifier. One skilled in the art will appreciate that this specific embodiment is but one example and is not intended to be limiting.

In one example, there may be a one-to-one mapping of a service path identifier to a VPN identifier. In another example, there may be a one-to-many mapping of VPN identifier to service path identifiers. For a single VPN identifier, there may be many service path identifiers. The service path identifiers may be, for example, traffic classification identifiers.

While examples have been provided describing how an SIA and a VPN can interact, one skilled in the art will appreciate that a more general use case is available. For example, where there is a central authority that can establish, maintain, and distribute mapping information, it may be possible to implicitly encode information that facilitates routing traffic back onto a first forwarding plane after it has transited a second forwarding plane having potentially incompatible routing data and/or processes. For example, in a client server architecture, clients may be able to talk to each other and may be able to talk to the server. A first logical grouping of clients may route traffic using a first combination of data and processes while a second logical grouping of clients may route traffic using a second combination of data and processes. But some traffic may want to travel over members of both the first logical grouping and the second logical grouping. When the server understands the two combinations of data and processes, the server may implicitly encode information associated with the first combination into data useable by the second combination and vice versa. Thus, the two potentially incompatible combinations may be able to interact without requiring complex signaling protocols. Instead, entry points and exit points associated with the logical groupings may be reconfigured to encode and/or decode mapping information to facilitate re-routing.

Because the encoding of forwarding information is implicit, adaptations to existing platforms may be limited to interfaces between the two logical groupings. At an entry interface, the implicit encoding may occur while at an exit interface decoding of the implicitly encoded information may occur. Since the information is implicitly encoded, intermediate points between an entry point and an exit point may process normally, remaining unaware that any information is implicitly encoded in traffic they are forwarding.

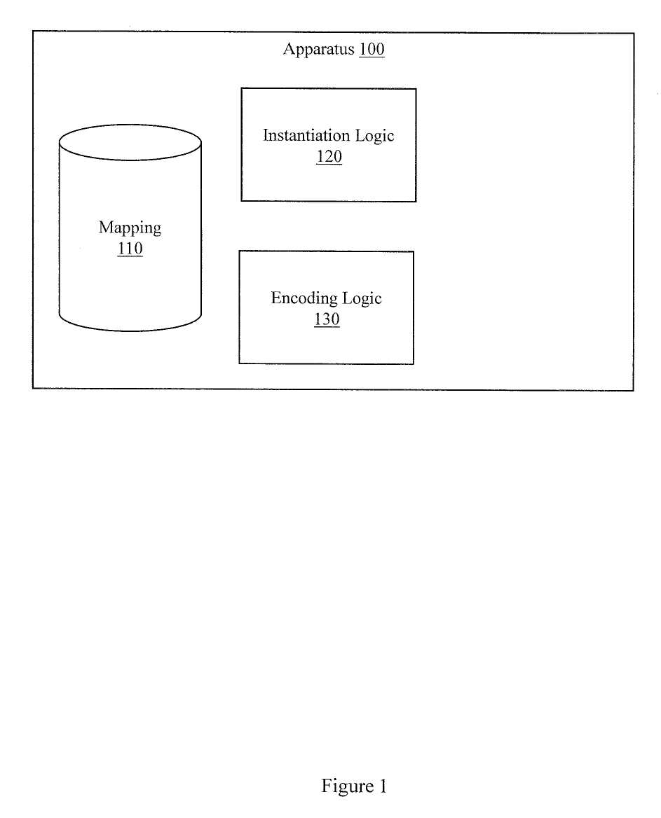

FIG. 1 illustrates an example apparatus 100 associated with interworking a VPN and an SIA. Apparatus 100 includes a mapping data store 110. Mapping data store 110 is configured to store a mapping between a first logical group of network devices and a second logical group of network devices. In one example, the first logical group may be associated with a VPN and the second logical group may be associated with an SIA. Thus, the first logical group and the second logical group may employ separate forwarding planes that are at least partially incompatible. For example, the VPN may be associated with a private forwarding domain while the SIA is associated with a global forwarding domain.

Apparatus 100 may also include an instantiation logic 120. Instantiation logic 120 may be configured to establish the mapping. The mapping may be based, at least in part, on a first unique identifier associated with the first logical group and a second unique identifier associated with the second logical group. In one example, the mapping may be a one-to-one mapping between the first logical group and the second logical group while in another example, the mapping may be a one-to-many mapping between the first logical group and the second logical group. One skilled in the art will appreciate that there are various ways to store both one-to-one and one-to-many mappings. For example, a record in a database may be manipulated, an entry in a table may be manipulated, a set of pointers may be manipulated, and so on. In different examples, the first unique identifier may be a Global VPN Identifier configured according to RFC 2685, a VNET identifier configured according to Cisco Network Virtualization technology, a route-target configured according to RFC 4364, and so on. In one example, the second unique identifier may be a service path identifier. One skilled in the art will appreciate that the mapping is stored as a data and thus establishing the mapping creates a physical transformation in a computer memory.

Apparatus 100 also includes an encoding logic 130. Encoding logic 130 may be configured to implicitly encode information to identify the first logical group in a packet received from the first logical group. The packet can then be provided to the second logical group. Implicitly encoding refers to manipulating a field that would already be present in, for example, the SIA packet, so that it conveys both SIA information and VPN information. For example, an SIA service header may be established that provides information traditionally found in an SIA service header but that also facilitates resolving a VPN to SIA mapping. Thus, the implicitly encoded information is configured to be used without modification by the forwarding plane associated with the second logical group.

Recall that a packet will eventually leave the forwarding plane employed by the second logical group and attempt to re-enter the forwarding plane employed by the first logical group. Therefore, the implicitly encoded information is configured to facilitate a member of the second logical group resolving the mapping. This member would likely be the exit point from the second logical group. This may be, for example, the last service node in a service path. At this point, the SIA packet will be forwarded to a device in the VPN, and thus the mapping facilitates a member of the second logical group forwarding the packet from the second logical group to a receiving member of the first logical group.

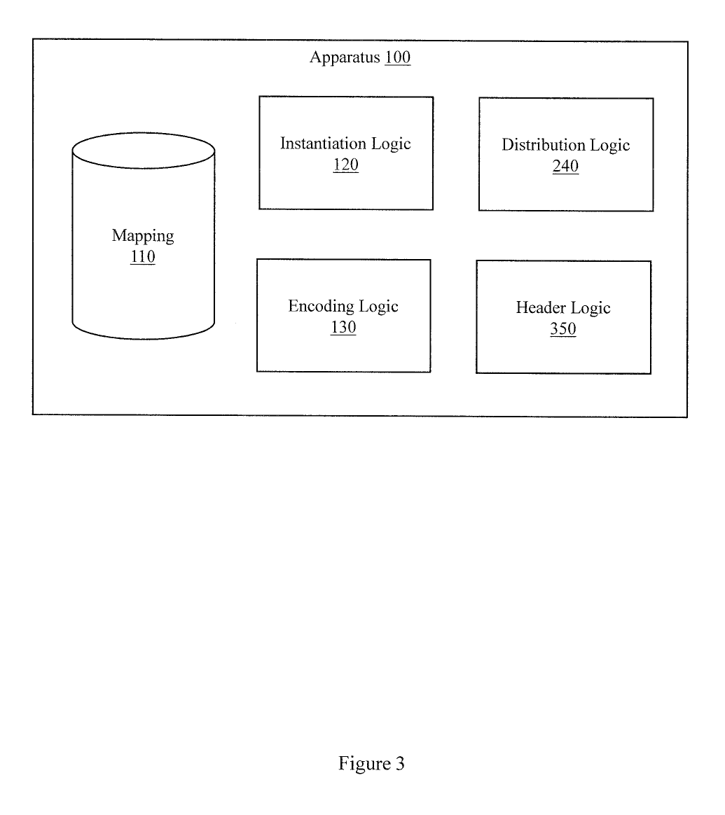

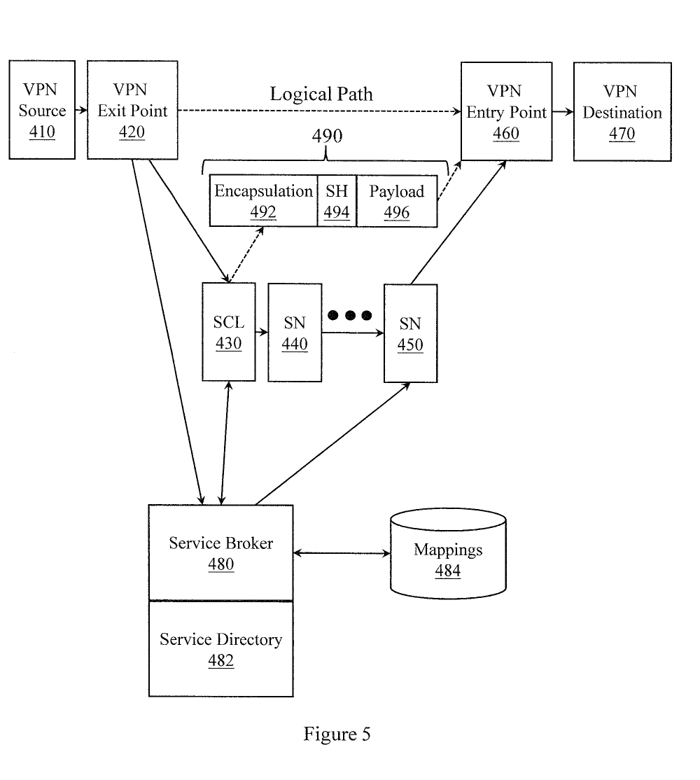

In one embodiment, the encoding logic 130 is configured to provide the identifying information to an SIA switching table that is configured to store path segment information for SIA packet switching. The encoding logic 130 may also be configured to store the identifying information in a service header identifier that functions as an MPLS label in an MPLS VPN FIB table. In this embodiment, a member of the second logical group is configured to derive the VPN table identifier from the identifying information in the service header. In one embodiment, a VPN forwarding table is then selectable as a function of the VPN table identifier. FIGS. 3 and 5 discuss encapsulation that may be associated with packet processing in the VPN and/or the SIA. The encapsulation may include, for example, processing headers associated with packets.

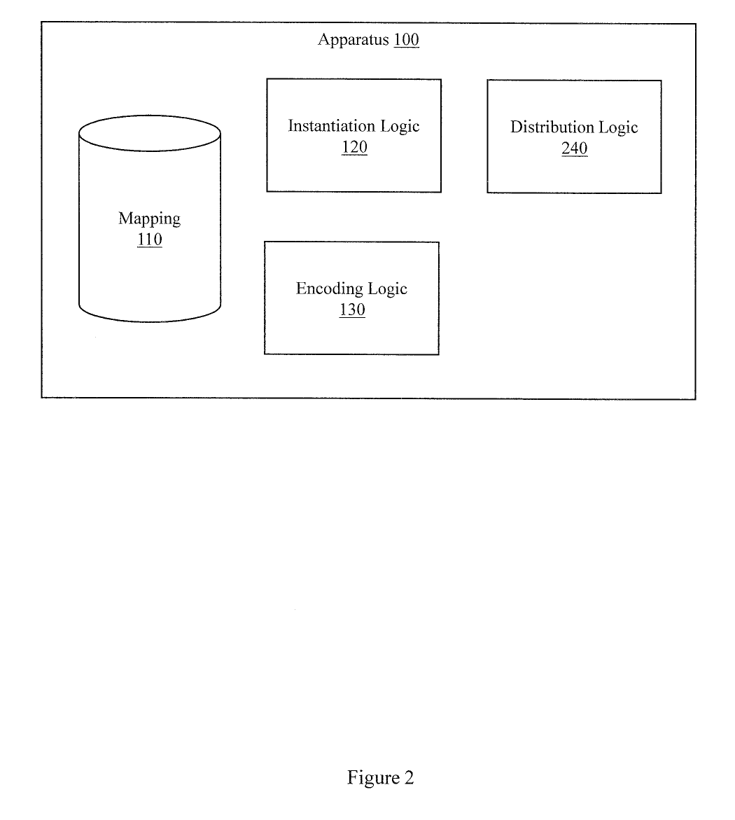

FIG. 2 illustrates another embodiment of apparatus 100. This embodiment of apparatus 100 includes a distribution logic 240. Distribution logic 240 is configured to distribute the mapping to a member of the second logical group. In one example, the distribution logic 240 may provide a record to the member, may provide a table to the member, may provide a decodable signal to the member, and so on. One skilled in the art will appreciate that there are various ways to distribute the mapping, all of which cause a physical transformation in a memory of the receiving device. Thus, apparatus 100 not only produces a concrete, tangible, real-world result in itself, but also controls another device to experience a physical transformation. The receiving device may store the information in, for example, an SIA switching table.

FIG. 3 illustrates another embodiment of apparatus 100. This embodiment includes a header logic 350. Header logic 350 is configured to control a member of the second logical group that receives a packet from a member of the first logical group. Header logic 350 is configured to control the member of the second logical group to add a service header to the packet. The information includes the identifying information. In one example, the header logic 350 is configured to insert the identifying information into the service header identifier of the packet. In one embodiment, the apparatus 100 is configured to control a member of the first logical group and/or a member of the second logical group to do VPN to SIA mapping, VPN identifier encoding, and/or VPN identifier decoding. These actions may be performed using a multi-protocol label switching (MPLS) VPN forwarding information base (FIB) ternary content addressable memory (TCAM).

The apparatus 100 is described as having logics. “Logic”, as used herein with reference to figures one through three, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

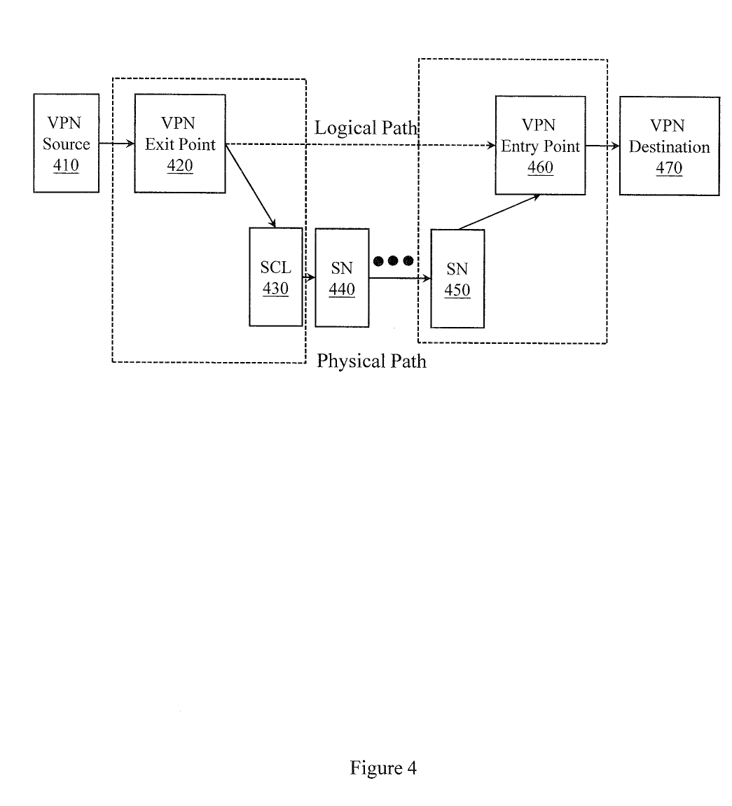

FIG. 4 illustrates an example environment in which a VPN and an SIA interact. A packet may be considered to enter the environment at VPN source 410. The packet may transit a number of hops in the VPN and eventually arrive at VPN exit point 420. Exit point 420 is where the physical path may diverge from a logical path. From the point of view of a VPN, the packet may transit from VPN exit point 420 to VPN entry point 460. However, the actual physical hop path may transit the identified physical path. The physical path may include a service classifier (SCL) 430 where the packet enters the SIA forwarding plane. The physical path may also include a set of service nodes including service node (SN) 440 through SN 450. After arriving at the end of a service path, (e.g., SN 450), the packet may be provided back to the VPN forwarding plane at VPN entry point 460. Example systems and methods facilitate not only providing the packet back to the VPN forwarding plane at VPN entry point 460 but also providing information that facilitates the VPN forwarding plane forwarding the packet to the VPN destination 470. Information about the VPN destination 470 would have been included in the VPN packet known to the VPN source 410. This information was implicitly encoded into the SIA packet created in SCL 430 that then progressed through the service path 430, 440, . . . 450. While the term “exit point” is employed for point 420, one skilled in the art will appreciate that more generally point 420 may be referred to as a VPN/SIA interface point. The ultimate egress point from the VPN will be at point 470. Point 420 represents a point where packets “exit” the pure VPN path and enter the combined VPN/SIA path. While FIGS. 4 and 5 illustrate VPN exit point 420 and SCL 430 being separate entities, these are intended to illustrate separate logical entities. One skilled in the art will appreciate that 420 and 430 could reside in a single physical device. This applies to 450 and 460 as well. Similarly, VPN entry point 460 represents a point where packets re-enter the pure VPN path and leave the VPN/SIA path.

FIG. 5 illustrates in greater detail the example environment introduced in FIG. 4. A service broker 480 interacts with both the VPN exit point 420 and the SCL 430. The service broker 480 may also interact with a service directory 482 and a mappings data store 484. The service broker 480 may be informed that a packet is to be provided from VPN exit point 420 to SCL 430 and that the packet is intended for a VPN destination. The service broker may determine whether a mapping between the VPN and the service path already exists and, if so, may provide a mapping from mappings data store 484. If a mapping does not already exist, then service broker 480 may create this mapping, provide it to the service classifier 430, and store it in the mappings data store 484.

The service classifier 430 may then classify the incoming packet and generate an outgoing packet 490. Packet 490 may include encapsulation information 492, a service header 494, and a payload 496. In one example, the mapping information may be stored in the service header 494. The service header 494 still needs to perform its original role in the SIA forwarding plane. Thus, the service header 494 must still provide information that is known to and useable by members of the service path. The members of the service path are to use this information without having to be modified. Thus, the information is said to be “implicitly encoded” in the service header 494. While in the VPN/SIA path (e.g., 430, 440, 450) the packet may include encapsulation 492, service header 494, and payload 496. While in the pure VPN path (e.g., 410, 420, 460, 470), a packet may include payload 496 and, optionally, some encapsulation. SN 450 hands over a packet to VPN entry point 460. Before handing over the packet, SN 450 may remove SH 494.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

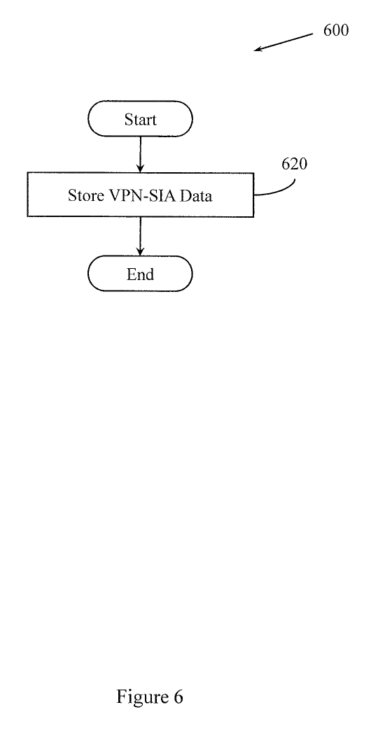

FIG. 6 illustrates an example method 600 associated with interworking a VPN and an SIA. Method 600 includes, at 620, storing VPN-SIA interaction data. After being received in the service classifier (SCL), information may be stored in an SIA service header identifier that is added to the packet. Thus, method 600 produces a concrete, tangible result that produces a physical transformation in a packet. In one example, the VPN-SIA interaction data is associated with both an SIA forwarding plane operating in a global forwarding domain and with a VPN forwarding plane operating in a private forwarding domain. Thus, the VPN-SIA interaction data facilitates operating an SIA architecture in VPN aware network. In one example, the VPN-SIA interaction data represents a mapping between a VPN unique identifier associated with the VPN and an SIA service path identifier associated with a service path associated with an SIA. The unique identifiers may take different forms as described above. The information may be added to the SH by the SCL after the handoff from the VPN to the SCL.

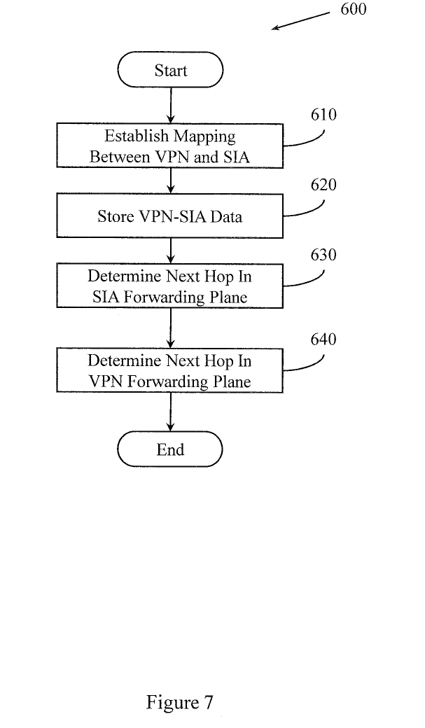

FIG. 7 illustrates another embodiment of method 600. This embodiment includes, at 610, establishing the mapping between the VPN and the SIA. The mapping may be established at different times. In one example, the mapping may be established by the service borker upon detecting a request from an SCL. Establishing the mapping may include, for example, updating a mapping data store, establishing an entry in a mapping data store, updating a record in a database, creating a record in a database, updating a table entry, creating a table entry, and so on. One skilled in the art will appreciate that the mapping is a physical item that is stored in a tangible medium (e.g., computer memory).

This embodiment of method 600 also includes, at 630, determining a next hop in the SIA forwarding plane. The next hop is determined, at least in part, as a function of analyzing the VPN-SIA interaction data. This embodiment of method 600 also includes, at 640, determining a next hop in the VPN forwarding plane. This next hop is determined, at least in part, as a function of decoding the VPN-SIA interaction data in the SIA forwarding plane. Thus, the VPN-SIA interaction data serves two roles, one in the SIA forwarding plane and one associated with the VPN forwarding plane. Service nodes employing the SIA forwarding plane do not need to be updated to determine the next hop. Thus, the VPN-SIA interaction data is said to be “implicitly encoded” in the SIA packet.

While FIG. 7 illustrates various actions occurring in serial, it is to be appreciated that various actions illustrated in FIG. 7 could occur substantially in parallel. By way of illustration, a first process could establish mappings, a second process could store VPN-SIA data, a third process could determine next hops in an SIA forwarding plane, and a fourth process could determine next hops in a VPN forwarding plane. While four processes are described, it is to be appreciated that a greater and/or lesser number of processes could be employed and that lightweight processes, regular processes, threads, and other approaches could be employed.

In one example, executable instructions associated with performing a method may embodied as logic encoded in one or more tangible media for execution. When executed, the instructions may perform a method. Thus, in one example, a logic encoded in one or more tangible media may store computer executable instructions that if executed by a machine (e.g., processor) cause the machine to perform method 600. While executable instructions associated with the above method are described as being embodied as a logic encoded in one or more tangible media, it is to be appreciated that executable instructions associated with other example methods described herein may also be stored on a tangible media.

A “tangible media”, as used herein, refers to a medium that stores signals, instructions and/or data. A tangible media may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a tangible media may include, but are not limited to, a floppy disk, a flexible disk, a hard disk, a magnetic tape, other magnetic medium, an application specific integrated circuit (ASIC), a compact disk CD, other optical medium, a random access memory (RAM), a read only memory (ROM), a memory chip or card, a memory stick, and other media from which a computer, a processor or other electronic device can read.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

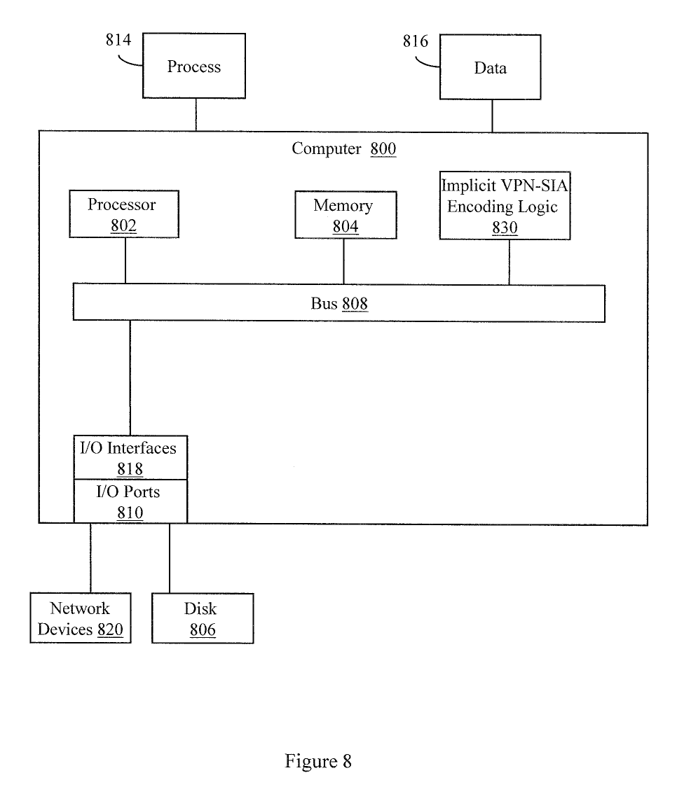

FIG. 8 illustrates an example computing device in which example systems and methods described herein, and equivalents, may operate. The example computing device may be a computer 800 that includes a processor 802, a memory 804, and input/output ports 810 operably connected by a bus 808. While a computer 800 is described, one skilled in the art will appreciate that a networking device (e.g., router, bridge, gateway) may be employed. In one example, the computer 800 may include a logic 830 configured to implicitly encode VPN-SIA information. In different examples, the logic 830 may be implemented in hardware, software, firmware, and/or combinations thereof. While the logic 830 is illustrated as a hardware component attached to the bus 808, it is to be appreciated that in one example, the logic 830 could be implemented in the processor 802.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

Logic 830 may provide means (e.g., hardware, software, firmware) for implicitly encoding data in a packet provided to an SIA by a VPN. The data that is implicitly encoded into the SIA packet is configured to facilitate forwarding in a VPN forwarding plane. Furthermore, the data that is implicitly encoded into the SIA packet is configured to be processed without modification in an SIA forwarding plane. The means may be implemented, for example, as an ASIC programmed to control a router. The means may also be implemented as computer executable instructions that are presented to computer 800 as data 816 that are temporarily stored in memory 804 and then executed by processor 802.

Generally describing an example configuration of the computer 800, the processor 802 may be a variety of various processors including dual microprocessor and other multi-processor architectures. A memory 804 may include volatile memory and/or non-volatile memory. Non-volatile memory may include, for example, ROM, programmable ROM (PROM), and so on. Volatile memory may include, for example, RAM, static RAM (SRAM), dynamic RAM (DRAM), and so on.

A disk 806 may be operably connected to the computer 800 via, for example, an input/output interface (e.g., card, device) 818 and an input/output port 810. The disk 806 may be, for example, a magnetic disk drive, a solid state disk drive, a floppy disk drive, a tape drive, a Zip drive, a flash memory card, a memory stick, and so on. Furthermore, the disk 806 may be a CD-ROM drive, a CD recordable (CD-R) drive, a CD rewriteable (CD-RW) drive, a digital versatile disk and/or digital video disk read only memory (DVD ROM), and so on. The memory 804 can store a process 814 and/or a data 816, for example. The disk 806 and/or the memory 804 can store an operating system that controls and allocates resources of the computer 800.

The bus 808 may be a single internal bus interconnect architecture and/or other bus or mesh architectures. While a single bus is illustrated, it is to be appreciated that the computer 800 may communicate with various devices, logics, and peripherals using other busses (e.g., peripheral component interconnect express (PCIE), 1384, universal serial bus (USB), Ethernet). The bus 808 can be types including, for example, a memory bus, a memory controller, a peripheral bus, an external bus, a crossbar switch, and/or a local bus.

The computer 800 may interact with input/output devices via the i/o interfaces 818 and the input/output ports 810. Input/output devices may be, for example, a keyboard, a microphone, a pointing and selection device, cameras, video cards, displays, the disk 806, the network devices 820, and so on. The input/output ports 810 may include, for example, serial ports, parallel ports, and USB ports.

The computer 800 can operate in a network environment and thus may be connected to the network devices 820 via the i/o interfaces 818, and/or the i/o ports 810. Through the network devices 820, the computer 800 may interact with a network. Through the network, the computer 800 may be logically connected to remote computers. Networks with which the computer 800 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. An apparatus, comprising:
a mapping data store to store a mapping between a first logical group of network devices and a second logical group of network devices, where the first logical group and the second logical group employ separate forwarding planes that are at least partially incompatible;
an instantiation logic configured to establish the mapping based, at least in part, on a first unique identifier associated with the first logical group and a second unique identifier associated with the second logical group; and
an encoding logic configured to implicitly encode information to identify the first logical group in a packet received from the first logical group, provided to the second logical group, and then provided back to the first logical group,
where the implicitly encoded information is configured to be used without modification by the forwarding plane associated with the second logical group,
where the implicitly encoded information is configured to facilitate a member of the second logical group resolving the mapping, and
where the mapping facilitates a member of the second logical group forwarding the packet from the second logical group to a receiving member of the first logical group.

2. The apparatus of claim 1, where the mapping is a one-to-one mapping between the first logical group and the second logical group.

3. The apparatus of claim 1, where the mapping is a one-to-many mapping between the first logical group and the second logical group.

4. The apparatus of claim 1, where the first logical group is a virtual private network (VPN).

5. The apparatus of claim 4, where the second logical group is a service insertion architecture (SIA).

6. The apparatus of claim 5, where a forwarding plane associated with the VPN is associated with a private forwarding domain and where a forwarding plane associated with the SIA is associated with a global forwarding domain.

7. The apparatus of claim 5, where the first unique identifier is one of, a Global VPN Identifier configured according to RFC 2685, a VNET identifier configured according to Cisco Network Virtualization technology, and a route-target configured according to RFC 4364.

8. The apparatus of claim 5, where the second unique identifier is a service path identifier.

9. The apparatus of claim 1, comprising a distribution logic configured to distribute the mapping to a member of the second logical group.

10. The apparatus of claim 5, comprising a header logic configured to control a member of the second logical group that receives a packet from a member of the first logical group to add a service header that includes the identifying information to the packet.

11. The apparatus of claim 10, where the header logic is configured to insert the identifying information into the service header identifier of the packet.

12. The apparatus of claim 1, where the encoding logic is configured to provide the identifying information to an SIA switching table that stores service path segment information for SIA packet switching.

13. The apparatus of claim 1, where the apparatus is configured to control a member of the second logical group, to perform one or more of, VPN to SIA mapping, VPN identifier encoding, and VPN identifier decoding, using a multi-protocol label switching (MPLS) VPN forwarding information base (FIB) ternary content addressable memory (TCAM).

14. The apparatus of claim 13, where the encoding logic is configured to store the identifying information in a service header identifier that functions similar to an MPLS label in an MPLS VPN FIB table, where a member of the second logical group is configured to derive the VPN table identifier, and where a VPN forwarding table is selectable as a function of the VPN table identifier.

15. The apparatus of claim 10, where the encoding logic and the header logic are located in a single physical device.

16. The apparatus of claim 10, where the encoding logic and the header logic are located in separate physical devices.

17. A logic encoded in one or more tangible media for execution and when executed operable to perform a method, the method comprising:
storing VPN-SIA interaction data in an SIA service header identifier embedded in a packet,
where the VPN-SIA interaction data is associated with both an SIA forwarding plane operating in a global forwarding domain and with a VPN forwarding plane operating in a private forwarding domain.

18. The logic of claim 17, where the VPN-SIA interaction data represents a mapping between a VPN unique identifier associated with the VPN and an SIA service path identifier associated with a service path associated with an SIA.

19. The logic of claim 18, the method comprising:
establishing the mapping between the VPN and the SIA upon detecting a request from the SCL.

20. The logic of claim 19, the method comprising:
determining a next hop in the SIA forwarding plane as a function of analyzing the VPN-SIA interaction data.

21. The logic of claim 18, the method comprising:
determining a next hop in the VPN forwarding plane as a function of decoding the VPN-SIA interaction data in the SIA forwarding plane.

22. The logic of claim 17, where both VPN functionality and SIA functionality are performed in a single physical device.

23. The logic of claim 17, where VPN functionality and SIA functionality are separately performed in different physical devices.

24. A system, comprising:
means for implicitly encoding data in a packet provided to an SIA by a VPN, where the data is configured to facilitate forwarding in a VPN forwarding plane, and where the data is processed without modification in an SIA forwarding plane.
